(19) United States
(12) Patent Application Publication
(10) Pub. No.: US 2021/0055870 A1
(43) Pub. Date: Feb. 25, 2021

(54) METHOD FOR MANAGING SECURE LIBRARY SUPPORTING DATA STORAGE, AND ASSOCIATED ELECTRONIC DEVICE

(71) Applicant: Artery Technology Co., Ltd., Chongqing (CN)

(72) Inventor: Chun-Yuan Lai, Chongqing (CN)

(21) Appl. No.: 16/747,539

(22) Filed: Jan. 21, 2020

(30) Foreign Application Priority Data
Aug. 23, 2019 (CN) 201910782325.2

(51) Int. Cl. G06F 3/06; G06F 21/60

(52) U.S. Cl. CPC G06F 3/0623; G06F 21/604; G06F 3/0679; G06F 3/0659; G06F 3/0644

(57) ABSTRACT

A method for managing a secure library supporting data storage and an associated electronic device are provided. The method includes: configuring at least one first sub-region and at least one second sub-region in a secure library region within a non-volatile memory to be an instruction region and a data region of the secure library, respectively; after the secure library is enabled, utilizing a memory controller to prevent any write operation and any erase operation from being applied to the secure library region, in order to protect the predetermined instructions and the predetermined data respectively positioned in the instruction region and the data region; and after the secure library is enabled, utilizing at least one processor to read the instruction region and the data region via an instruction port and a data port of the at least one processor, respectively.

### BACKGROUND OF THE INVENTION

### 1. Field of the Invention

The present invention relates to controlling associated electronic products, and more particularly, to a method for managing a secure library supporting data storage, and an associated electronic device.

### 2. Description of the Prior Art

In related art techniques, a library may be used for storing program codes for further use. For example, these program codes may be executed, but they cannot be read or altered by users. A solution provider may sell integrated circuit (IC) products equipped with these program codes that have been recorded (e.g. “burned”, according to some viewpoints) therein in advance to a system manufacturer, for performing secondary development. Since these program codes can neither be read nor altered, such mechanism is helpful on protecting these program codes from being stolen, to maintain such business model. However, some problems may occur. For example, the library in the related art techniques can merely store instructions, and typically, data must be placed in other location(s). During the secondary development, the data may be unintentionally damaged, or even be intentionally altered. Hence, there is a need for a novel architecture to improve the protection mechanism and enhance the overall performance of the electronic system.

### SUMMARY OF THE INVENTION

An objective of the present invention is to provide a method for managing a secure library supporting data storage, and an associated electronic device, in order to solve the aforementioned problems.

Another objective of the present invention is to provide a method for managing a secure library supporting data storage, and an associated electronic device, in order to improve protection mechanism and to achieve the optimal performance of the electronic device.

At least one embodiment of the present invention provides a method for managing a secure library supporting data storage. The method is applied to an electronic device. The method may comprise: configuring at least one first sub-region and at least one second sub-region in a secure library region within a non-volatile memory to be an instruction region and a data region of the secure library, respectively, wherein before the secure library is enabled, predetermined instructions and predetermined data belonging to the secure library are written into the instruction region and the data region via a data port of at least one processor respectively, in order to establish the secure library in the secure library region, and the at least one processor and the non-volatile memory are positioned in the electronic device; after the secure library is enabled, utilizing a memory controller to inhibit any write operation and any erase operation from being applied to the secure library region, in order to protect the predetermined instructions and the predetermined data respectively positioned in the instruction region and the data region, wherein the memory controller is positioned in the electronic device; and after the secure library is enabled, utilizing the at least one processor to read the instruction region and the data region via an instruction port and the data port of the at least one processor, respectively. According to some embodiments, the predetermined instructions may comprise at least one function, and the predetermined data may comprise one or more constants of the at least one function.

At least one embodiment of the present invention provides an electronic device that comprises at least one processor, a non-volatile memory and a memory controller. The least one processor is arranged to control operations of the electronic device, wherein the at least one processor comprises a data port and an instruction port. The non-volatile memory is arranged to store information for the electronic device and provide a secure library supporting data storage to the electronic device. The memory controller is coupled to the at least one processor and the non-volatile memory. The memory controller is arranged to configure at least one first sub-region and at least one second sub-region in a secure library region within the non-volatile memory to be an instruction region and a data region of the secure library, respectively, wherein before the secure library is enabled, predetermined instructions and predetermined data belonging to the secure library are respectively written into the instruction region and the data region via the data port of the at least one processor, in order to establish the secure library in the secure library region. After the secure library is enabled, the memory controller inhibits any write operation and any erase operation from being applied to the secure library region, in order to protect the predetermined instructions and the predetermined data respectively positioned in the instruction region and the data region. After the secure library is enabled, the at least one processor reads the instruction region and the data region via the instruction port and the data port of the at least one processor, respectively. According to some embodiments, the predetermined instructions may comprise at least one function, and the predetermined data may comprise one or more constants of the at least one function.

The present invention realizes the secure library supporting data storage without reducing the overall performance, and can achieve the optimal performance of the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to an embodiment of the present invention.

FIG. 2 illustrates implementation details of the memory controller in the electronic device shown in FIG. 1 according to an embodiment of the present invention.

FIG. 3 illustrates a control scheme of a method for managing a secure library supporting data storage according to an embodiment of the present invention.

FIG. 4 illustrates a working flow of the method shown in FIG. 3 according to an embodiment of the present invention.

### DETAILED DESCRIPTION

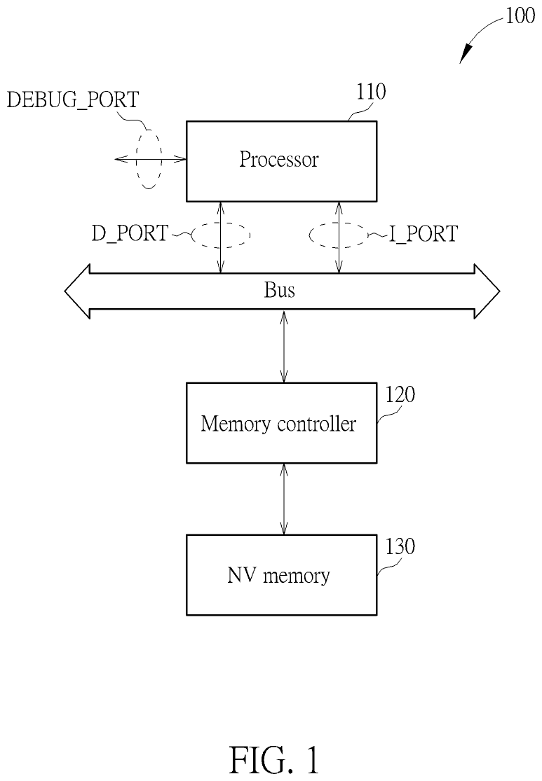

FIG. 1 is a diagram of an electronic device 100 according to an embodiment of the present invention. The electronic device 100 may comprise at least one processor (e.g. one or more processors) such as the processor 110, a memory controller 120 and a non-volatile (NV) memory 130, where the aforementioned at least one processor such as the processor 110 may comprise a debug port DEBUG_PORT, a data port D_PORT and an instruction port I_PORT. For example, the non-volatile memory 130 may be a flash memory, but the present invention is not limited thereto. In addition, the memory controller 120 may be coupled to the aforementioned at least one processor such as the processor 110 and the non-volatile memory 130. More particularly, the processor 110 may be coupled to the memory controller 120 via a bus, to access the non-volatile memory 130 under the control of the memory controller 120. Based on the architecture shown in FIG. 1, the processor 110 may perform debug-related transmission (e.g. receiving a debug command from outside of the processor 110 or returning the debug information), data accessing (e.g. reading or writing) and instruction reading via the debug port DEBUG_PORT, the data port D_PORT and the instruction port I_PORT, respectively. Examples of the electronic device 100 may include, but are not limited to: a multifunctional mobile phone, a notebook, a tablet, and a wearable device.

According to this embodiment, the aforementioned at least one processor such as the processor 110 may control operations of the electronic device 100, to allow the electronic device 100 to have various functions. Under the control of the memory controller 120, the non-volatile memory 130 may store information for the electronic device 100 and provide a secure library supporting data storage for the electronic device 100, for realizing the aforementioned various functions. Since the secure library can support data storage, the protection mechanism of the present invention can properly protect important data needed by the secure library, to guarantee that the important data will not be destroyed or tampered with.

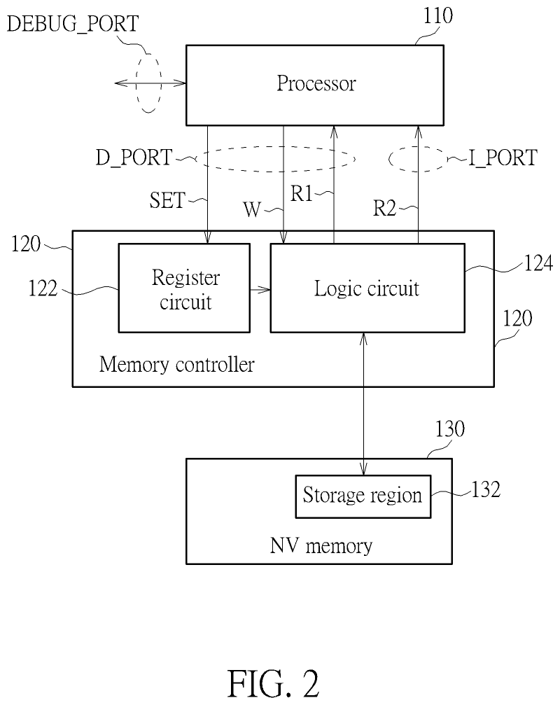

FIG. 2 illustrates implementation details of the memory controller 120 in the electronic device 100 shown in FIG. 1 according to an embodiment of the present invention. The memory controller 120 may comprise a register circuit 122 and a logic circuit 124, and the register circuit 122 may comprise multiple registers. The processor 110 may perform the setting operation SET, the write operation W and the read operation R1 via the data port D_PORT, and more particularly, may perform the setting operation SET on the register circuit 122, and perform the write operation W and the read operation R1 on the non-volatile memory 130 under the control of the logic circuit 124. In addition, the processor 110 may perform the read operation R2 on the non-volatile memory 130 via the instruction port I_PORT under the control of the logic circuit 124. For example, the aforementioned at least one processor such as the processor 110 may perform the setting operation SET on the register circuit 122 via the data port D_PORT to assign respective various access limitations of multiple sub-regions of the storage region 132 in the non-volatile memory 130, to make the logic circuit 124 control the respective permissions of the write operation W and the read operations R1 and R2 according to the setting results of the setting operation SET (e.g. the setting results stored in the register circuit 122), but the present invention is not limited thereto. According to this embodiment, the memory controller 120 may limit the accessing via comparing the access addresses, to make the secure library support data storage, and may merely allow the data port D_PORT to read important data in the secure library, to maintain the protection function of the secure library. This can be very beneficial. For example, assuming that the unpermitted data port access is temporarily masked through merely delaying, the dependency between the delay time and the processor architecture may make the library contents be unsafe. More particularly, if it is triggered to read via other master device(s) such as a direct memory access (DMA) circuit, there may be vulnerability. The architecture of the present invention is capable of completely eliminating these issues.

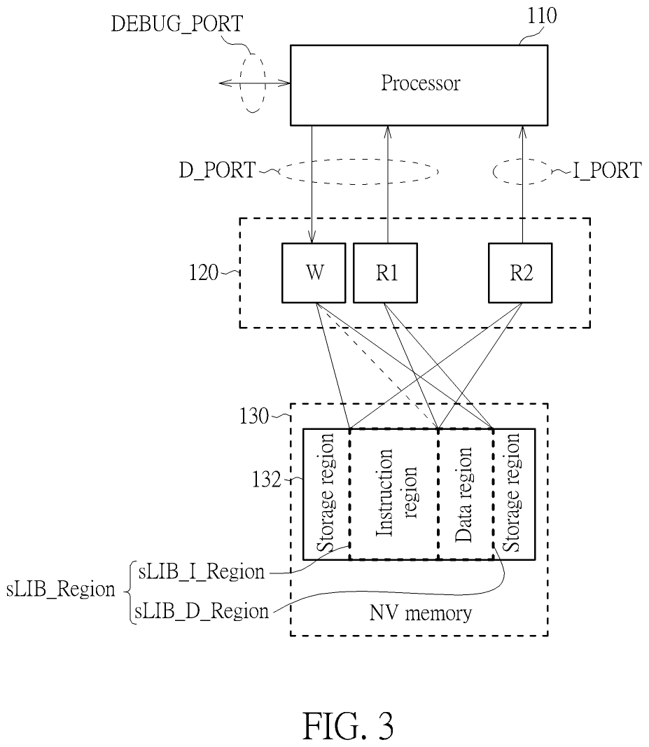

FIG. 3 illustrates a control scheme of a method for managing a secure library supporting data storage according to an embodiment of the present invention. The method may be applied to the electronic device 100 shown in FIG. 1, and more particularly, may be applied to the aforementioned at least one processor such as the processor 110, the memory controller 120 and the non-volatile memory 130. As shown in FIG. 3, the storage region 132 may comprise a secure library region sLIB_Region as well as other regions (e.g. one or more system manufacturer dedicated regions, one or more user regions, etc.), and the secure library region sLIB_Region may comprise an instruction region sLIB_I_Region and a data region sLIB_D_Region. Before the secure library is enabled, for example, during a manufacturing phase of at least one integrated circuit (IC) in the architecture shown in FIG. 1 (e.g. an IC product that comprises the processor 110, the memory controller 120, the non-volatile memory 130 and the bus), the aforementioned at least one processor such as the processor 110 may write predetermined instructions and predetermined data belonging to the secure library into the instruction region sLIB_I_Region and the data region sLIB_D_Region via the data port D_PORT, respectively, to establish the secure library in the secure library region sLIB_Region. For example, after the secure library is enabled, the memory controller 120 inhibits (e.g. prevents) any altering regarding the secure library region sLIB_Region, to protect the predetermined instructions and the predetermined data respectively positioned in the instruction region sLIB_I_Region and the data region sLIB_D_Region. According to some viewpoints, the secure library region sLIB_Region may represent the secure library, but the present invention is not limited thereto.

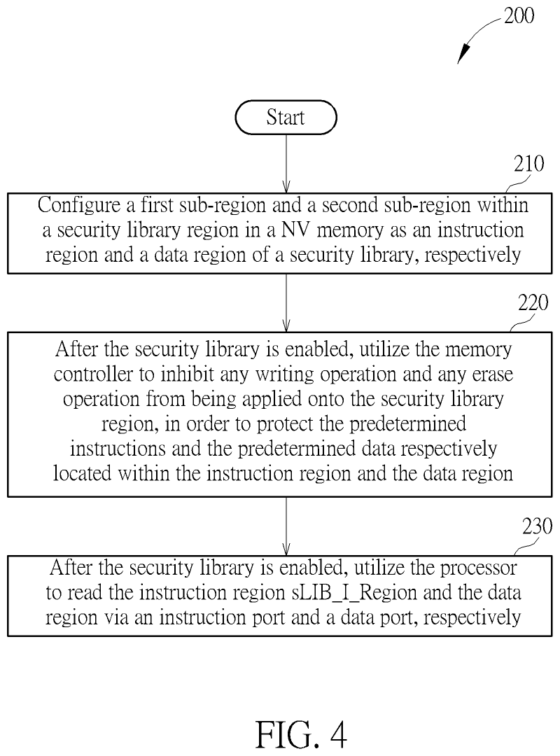

FIG. 4 illustrates a working flow 200 of the method shown in FIG. 3 according to an embodiment of the present invention. For better comprehension, the electronic device 100 (e.g. the aforementioned at least one processor such as the processor 110, the memory controller 120 and the non-volatile memory 130) may perform at least one portion (e.g. a portion or all) of the operations in Steps 210, 220 and 230 during at least one subsequent phase (e.g. one or more subsequent phases) of the manufacturing phase of the aforementioned IC (e.g. the IC product that comprises the processor 110, the memory controller 120, the non-volatile memory 130 and the bus), and may perform operations in the manufacturing phase before the execution of Step 210, but the present invention is not limited thereto. For example, the aforementioned at least one subsequent phase may comprise a first subsequent phase such as a secondary development phase, and more particularly, may further comprise a second subsequent phase such as a user phase. After the secure library is enabled, no matter being in which phase of these subsequent phases, the electronic device 100 that operates according to the method can properly protect the important data required by the secure library, to guarantee that these important data will not be destroyed or tampered with.

In Step 210, the electronic device 100 (e.g. the memory controller 120) may configure at least one first sub-region (e.g. one or more first sub-regions) and at least one second sub-region (e.g. one or more second sub-regions) in the secure library region sLIB_Region within the non-volatile memory 130 to be the instruction region sLIB_I_Region and the data region sLIB_D_Region of the secure library, respectively, where before the secure library is enabled, the predetermined instructions and the predetermined data belonging to the secure library are respectively written into the instruction region sLIB_I_Region and the data region sLIB_D_Region via the data port D_PORT of the processor 110, in order to establish the secure library in the secure library region sLIB_Region.

In Step 220, after the secure library is enabled, the electronic device 100 may utilize the memory controller 120 to inhibit (e.g. prevent) any write operation and any erase operation from being applied to the secure library region sLIB_Region, in order to protect the predetermined instructions and the predetermined data respectively positioned in the instruction region sLIB_I_Region and the data region sLIB_D_Region.

In Step 230, after the secure library is enabled, the electronic device 100 may utilize the processor 110 to read the instruction region sLIB_I_Region and the data region sLIB_D_Region via the instruction port I_PORT and the data port D_PORT of the processor 110, respectively.

Regarding the data port D_PORT, the electronic device 100 may utilize the memory controller 120 (for example, through operations of the data port D_PORT) to allow reading the data region sLIB_D_Region, rather than the instruction region sLIB_I_Region. More particularly, the electronic device 100 may utilize the memory controller 120 to inhibit the aforementioned at least one processor such as the processor 110 from reading the instruction region sLIB_I_Region via the data port D_PORT. In addition, the electronic device 100 may utilize the memory controller 120 to allow the aforementioned at least one processor such as the processor 110 to read the instruction region sLIB_I_Region via the instruction port I_PORT. For example, the electronic device 100 may utilize the memory controller 120 to inhibit the aforementioned at least one processor such as the processor 110 from reading the instruction region sLIB_I_Region via any other port, where the any other port comprises the data port D_PORT. In another example, the electronic device 100 may utilize the memory controller 120 to inhibit any other component in the electronic device 100 from reading the instruction region sLIB_I_Region. For brevity, similar descriptions for this embodiment are not repeated in detail here.

According to some embodiments, during the manufacturing phase, the aforementioned solution provider may use a production tool to trigger establishing the secure library in the secure library region sLIB_Region (e.g. writing the predetermined instructions and the predetermined data into the instruction region sLIB_I_Region and the data region sLIB_D_Region via the data port D_PORT, respectively), and more particularly, may use the production tool to enable the secure library, and may sell the aforementioned IC (e.g. the IC product that comprises the processor 110, the memory controller 120, the non-volatile memory 130 and the bus) to the aforementioned system manufacturer, for the system manufacturer to perform the secondary development during the secondary development phase. After the system manufacturer completes the secondary development, the system manufacturer may sell the electronic device 100 to the user, for the user to use in the user phase. For brevity, similar descriptions for these embodiments are not repeated in detail here.

According to some embodiments, the predetermined instructions may comprise at least one function (e.g. one or more functions) such as a function Function_A( ), and the predetermined data may comprise one or more constants of the aforementioned at least one function, such as one or more constants of the function Function_A( ). For example, the function Function_A( ) may have the following format:

Function_A( )
{
...
}

where the symbol “ . . . ” in the above format may represent the contents of the function Function_A( ), but the present invention is not limited thereto. In addition, the program(s) developed by the system manufacturer during the secondary development phase may be stored in the other regions (e.g. the one or more system manufacturer dedicated regions), and may comprise at least one other function (e.g. one or more other functions), such as a function Function_B( ) calling the function Function_A( ). For example, the function Function_B( ) may have the following format:

Function_B( )
{

Function_A( );

...
}

where the symbol “ . . . ” in the above format may represent the contents of the function Function_B ( ), but the present invention is not limited thereto. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a secure library supporting data storage, the method being applied to an electronic device, the method comprising:
configuring at least one first sub-region and at least one second sub-region in a secure library region within a non-volatile memory to be an instruction region and a data region of the secure library, respectively, wherein before the secure library is enabled, predetermined instructions and predetermined data belonging to the secure library are respectively written into the instruction region and the data region via a data port of at least one processor, in order to establish the secure library within the secure library region, and the at least one processor and the non-volatile memory are positioned in the electronic device;
after the secure library is enabled, utilizing a memory controller to inhibit any write operation and any erase operation from being applied to the secure library region, in order to protect the predetermined instructions and the predetermined data respectively positioned in the instruction region and the data region, wherein the memory controller is positioned in the electronic device; and
after the secure library is enabled, utilizing the at least one processor to read the instruction region and the data region via an instruction port and the data port of the at least one processor, respectively.

2. The method of claim 1, further comprising:
regarding the data port, utilizing the memory controller to allow reading the data region, rather than the instruction region.

3. The method of claim 1, further comprising:
utilizing the memory controller to inhibit the at least one processor from reading the instruction region via the data port.

4. The method of claim 1, further comprising:
utilizing the memory controller to allow the at least one processor to read the instruction region via the instruction port.

5. The method of claim 4, further comprising:
utilizing the memory controller to inhibit the at least one processor from reading the instruction region via any other port, wherein said any other port comprises the data port.

6. The method of claim 4, further comprising:
utilizing the memory controller to inhibit any other component in the electronic device from reading the instruction region.

7. An electronic device, comprising:
at least one processor, arranged to control operations of the electronic device, wherein the at least one processor comprises a data port and an instruction port;
a non-volatile memory, arranged to store information for the electronic device and provide a secure library supporting data storage to the electronic device; and
a memory controller, coupled to the at least one processor and the non-volatile memory, the memory controller arranged to configure at least one first sub-region and at least one second sub-region in a secure library region within the non-volatile memory to be an instruction region and a data region of the secure library, respectively, wherein before the secure library is enabled, predetermined instructions and predetermined data belonging to the secure library are respectively written into the instruction region and the data region via the data port of the at least one processor, in order to establish the secure library in the secure library region;
wherein:
after the secure library is enabled, the memory controller inhibits any write operation and any erase operation from being applied to the secure library region, in order to protect the predetermined instructions and the predetermined data respectively positioned in the instruction region and the data region; and
after the secure library is enabled, the at least one processor reads the instruction region and the data region via the instruction port and the data port of the at least one processor, respectively.

8. The electronic device of claim 7, wherein regarding the data port, the memory controller allows reading the data region, rather than the instruction region.

9. The electronic device of claim 7, wherein the memory controller inhibits the at least one processor from reading the instruction region via the data port.

10. The electronic device of claim 7, wherein the memory controller allows the at least one processor to read the instruction region via the instruction port.

11. The electronic device of claim 10, wherein the memory controller inhibits the at least one processor from reading the instruction region via any other port, wherein said any other port comprises the data port.

12. The electronic device of claim 10, wherein the memory controller inhibits any other component in the electronic device from reading the instruction region.
